(19) United States
(12) Patent Application Publication
(10) Pub. No.: US 2012/0096528 A1
(43) Pub. Date: Apr. 19, 2012

(54) IMAGE FORMING APPARATUS, INFORMATION PROCESSING METHOD, AND PROGRAM

(75) Inventor: Atsushi Daigo, Asaka-shi (JP)

(73) Assignee: CANON KABUSHIKI KAISHA, Tokyo (JP)

(21) Appl. No.: 13/240,269

(22) Filed: Sep. 22, 2011

(30) Foreign Application Priority Data
Oct. 14, 2010 (JP) 2010-231907

(51) Int. Cl. H04L 9/32; G06F 15/16; G06F 21/00

(52) U.S. Cl. 726/7

(57) ABSTRACT

To provide an authentication method of enabling a user to use a multifunction machine in which user information of the user is not registered on an authentication table thereof, without deteriorating a maintenance capability of the authentication table, the method is characterized to include steps of obtaining user information from the user, determining whether or not the obtained user information is included on a user information table, and transmitting, when the obtained user information is not included on the user information table, the user information to an image forming apparatus registered in a redirect destination list. The method is further characterized to cause the transmission-destination image forming apparatus to authenticate the transmitted user information, and permit use of the image forming apparatus by the user according to an authentication result of the transmission-destination image forming apparatus.

### BACKGROUND OF THE INVENTION

1. Field of the Invention

The present invention relates to an authentication method to be performed in a case where an image forming apparatus is used.

2. Description of the Related Art

In recent years, security for a multifunction machine serving as an information input/output unit comes to be required according to an increase in security for an office. Consequently, a concept of “authentication” comes to be applied to the multifunction machine as well as a PC (personal computer).

Here, when the authentication is actually performed, an authentication system in which an IC card is used is preferred in the market because of its high usability. Incidentally, to achieve the authentication system like this, a table for managing the ties between card numbers and user information is necessary. Generally, in an environment of a large-scale facility, an authentication server is set up so as to correspond to the system which includes a plurality of multifunction machines. On the other hand, in an environment of a small-scale facility, a method of uniquely managing the table within an authentication application is provided.

Here, the environment of the small-scale facility does not often have a system administrator.

In other words, there is a situation that the table information in the authentication application is not integrally managed by an information system division or the like, but is independently managed by each division which actually uses the multifunction machine.

In the situation like this, for example, there is a problem that a user who belongs to a certain division cannot log in to the multifunction machine which is managed by another division.

To log in to the plurality of multifunction machines, it is necessary to register the user information to the authentication tables of all of the plurality of multifunction machines to be used. However, this is not practical if a problem of maintenance is considered.

Further, it is also conceivable to mutually synchronize the plurality of authentication tables with others. However, there is a possibility that unintended user information is erroneously or intentionally deleted in the multifunction machine which is managed by each division, whereby such a method is off from practical use.

To solve such problems as described above, Japanese Patent Application Laid-Open No. 2007-235706 discloses a mechanism of, when accepting user identification information (user ID) of a user, obtaining information of the user from a multifunction machine in which the information of the user has been registered.

By using the above mechanism, the user can use the desired multifunction machine on a network. However, when the user actually uses the multifunction machine, it is necessary to move the user's user information. As a result, since the information itself in which the user oneself has been registered is moved, it becomes difficult to manage the relevant information for each division.

### SUMMARY OF THE INVENTION

The present invention has been completed in consideration of the above-described problems, and an object thereof is to provide a mechanism of enabling a user to use a multifunction machine in which user information of the user is not registered on an authentication table thereof, without deteriorating a maintenance capability of the authentication table.

To achieve the above object, the present invention is characterized by an image forming apparatus which stores user IDs and communicates with another image forming apparatus, comprising: an accepting unit configured to accept input of a user ID; a determining unit configured to determine whether the accepted user ID corresponds to one of the stored user IDs; a controlling unit configured to, in a case where the determining unit determines that the accepted user ID corresponds one of the stored user IDs, permit use of the image forming apparatus by the user; a transmitting unit configured to, in a case where the determining unit determines that the accepted user ID corresponds to none of the stored user IDs, transmit an authentication request including the accepted user ID to the other image forming apparatus; and a receiving unit configured to receive an authentication result for the transmitted authentication request, from the other image forming apparatus, wherein the controlling unit permits, in a case where the received authentication result indicates that authentication succeeded, the use of the image forming apparatus by the user.

Further features of the present invention will become apparent from the following description of exemplary embodiments with reference to the attached drawings.

### BRIEF DESCRIPTION OF THE DRAWINGS

FIG. 1 is a schematic view illustrating a system configuration according to the embodiment of the present invention.

FIG. 2 is a block diagram illustrating a hardware constitution of a client PC according to the embodiment of the present invention.

FIG. 3 is a block diagram illustrating a hardware constitution of a multifunction machine according to the embodiment of the present invention.

FIG. 4 is a functional block diagram illustrating the system configuration according to the present invention.

FIG. 5 is a flow chart illustrating an example of an IC card authentication process according to the embodiment of the present invention.

FIG. 6 is a flow chart illustrating an example of a first redirect authentication process in the IC card authentication process according to the embodiment of the present invention.

FIG. 7 is a flow chart illustrating an example of the redirect authentication process to be performed when an authentication process request from another multifunction machine is accepted, in the embodiment of the present invention.

FIG. 8 is a view illustrating an example of an authentication table to be managed in a ROM (read only memory) 5002 of a multifunction machine 200, in the present invention.

FIG. 9 is a view illustrating an example of a redirect card list to be managed in the ROM 5002 of the multifunction machine 200, in the present invention.

FIG. 10 is a view illustrating an example of a redirect-destination multifunction machine list to be managed in the ROM 5002 of the multifunction machine 200, in the present invention.

FIG. 11 is a view illustrating an example of an IC card authentication screen to be displayed on the operation unit of the multifunction machine 200, in the present invention.

FIG. 12 is a view illustrating an example of a redirect-destination multifunction machine selection screen to be displayed on the operation unit of the multifunction machine 200, in the present invention.

FIG. 13 is a view illustrating an example of an authentication error screen to be displayed on the operation unit of the multifunction machine 200, in the present invention.

### DESCRIPTION OF THE EMBODIMENTS

Hereinafter, the embodiment of the present invention will be described with reference to the attached drawings.

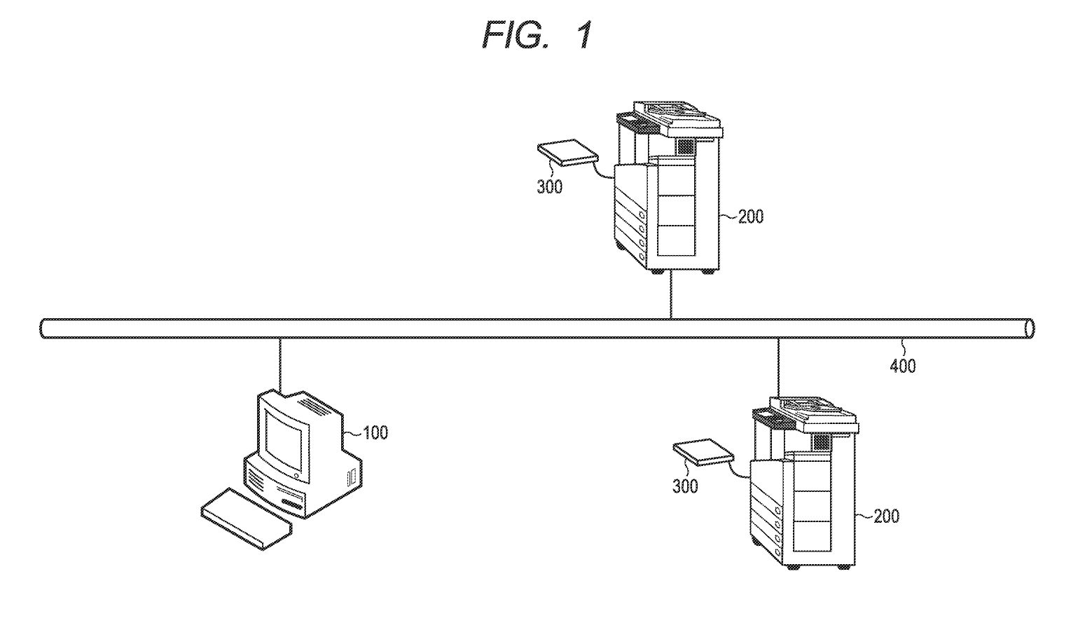

FIG. 1 is a schematic view illustrating an example of a configuration of a security system of the present invention, which includes a multifunction machine (image forming apparatus), an IC card reader and a client PC.

More specifically, a client PC 100 is communicably connected to multifunction machines 200 through a LAN (local area network) 400, and a card reader 300 is connected to each of the multifunction machines 200.

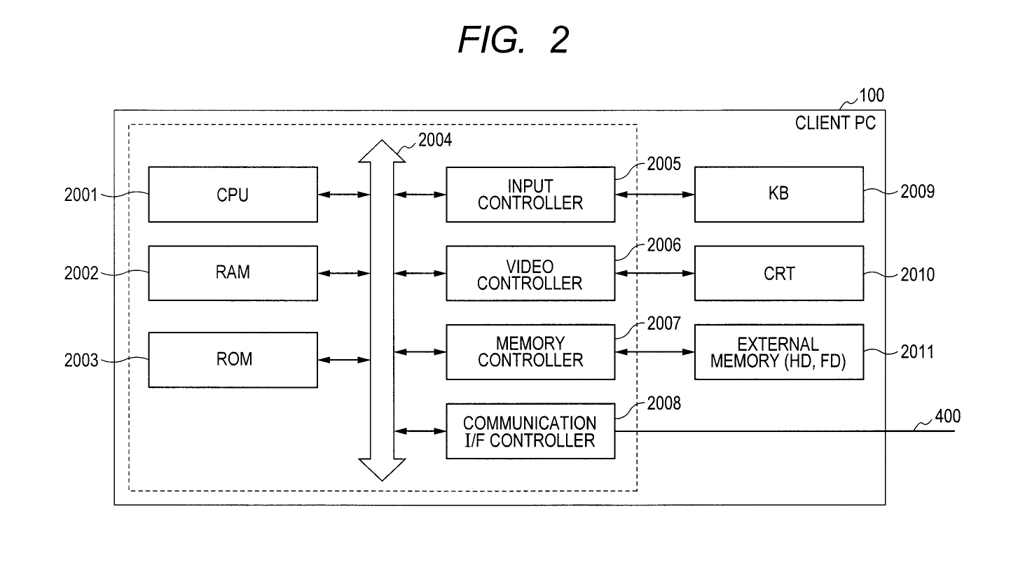

Hereinafter, a hardware constitution of an information processing apparatus which is applicable to the client PC 100 illustrated in FIG. 1 will be described with reference to FIG. 2.

In FIG. 2, a CPU (central processing unit) 2001 totally controls devices and controllers respectively connected to a system bus 2004. Incidentally, BIOS (Basic Input/Output System) serving as a control program for the CPU 2001, an OS (operating system) also serving as a control program, various programs necessary to achieve functions to be performed by each server, each PC and the like, and the like are stored in a ROM (read only memory) 2003 or an external memory 2011.

A RAM (random access memory) 2002 serves as a main memory, a working area and the like for the CPU 2001. In case of performing a process, the CPU 2001 loads a program or the like necessary for the process from the ROM 2003 or the external memory 2011 to the RAM 2002, and then executes the loaded program or the like to perform the process.

An input controller 2005 controls inputs from a KB (keyboard) 2009, a pointing device such as a not-illustrated mouse, and the like. A video controller 2006 controls display to be performed on a display device such as a CRT (cathode ray tube) 2010. Incidentally, although the CRT 2010 is illustrated as the display device in FIG. 2, another display device such as a liquid crystal display or the like may be used. In any case, the display device is used by a client as necessary.

A memory controller 2007 controls access to an HD (hard disk), an FD (flexible disk), or the external memory 2011 such as a CompactFlash™ memory or the like connected to a PCMCIA (Personal Computer Memory Card International Association) card slot through an adapter, which stores a boot program, various applications, font data, user files, edit files, various data and the like.

A communication I/F (interface) controller 2008, which connects to and communicates with an external apparatus through a network (for example, the LAN 400 illustrated in FIG. 1), performs a communication control process on the network. For example, the communication I/F controller 2008 can perform communication using TCP/IP (Transmission Control Protocol/Internet Protocol), or the like.

Incidentally, the CPU 2001 enables display on the CRT 2010 by, for example, performing an extracting (rasterizing) process of an outline font to a display information region in the RAM 2002. Further, the CPU 2001 enables a user instruction using a not-illustrated mouse cursor on the CRT 2010.

Various programs which operate on hardware have been stored and recorded in the external memory 2011, these programs are loaded to the RAM 2002 as necessary, and the loaded programs are executed by the CPU 2001.

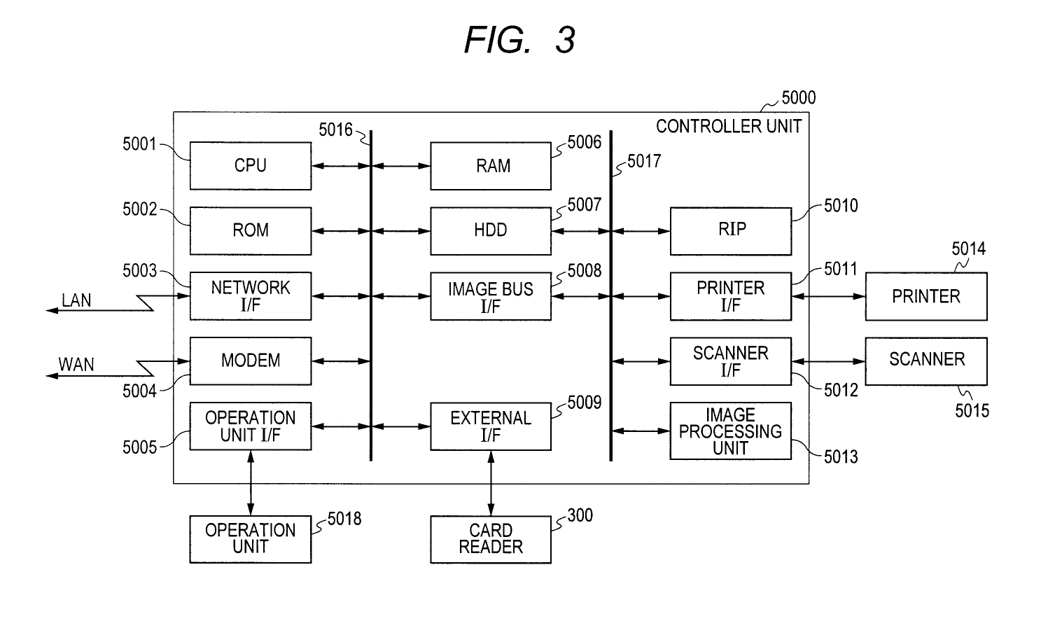

Subsequently, a hardware constitution of the controller unit which controls the multifunction machine 200 serving as the information processing apparatus according to the present invention will be described with reference to FIG. 3.

FIG. 3 is the block diagram illustrating a hardware constitution of a controller unit 5000 of the multifunction machine 200.

In FIG. 3, the controller unit 5000 is connected to a scanner 5015 functioning as an image input device and a printer 5014 functioning as an image output device. Further, the controller unit 5000, which is connected to a local area network such as the LAN 400 of FIG. 1, or a WAN (wide area network) such as a PSTN (public switched telephone network), an ISDN (Integrated Services Digital Network) or the like, inputs and outputs image data and device information.

As illustrated in FIG. 3, the controller unit 5000 includes a CPU 5001, a RAM 5006, a ROM 5002, an external memory apparatus (HDD (hard disk drive)) 5007, a network I/F 5003, a modem 5004, an operation unit I/F 5005, an external I/F 5009, an image bus I/F 5008, an RIP (raster image processor) 5010, a printer I/F 5011, a scanner I/F 5012, an image processing unit 5013, and the like.

The CPU 5001 is the processor which wholly controls the system.

The RAM 5006 is the system working memory to be used when the CPU 5001 operates. Also, the RAM 5006 serves as a program memory for recording programs and an image memory for temporarily storing image data.

The ROM 5002 stores therein a boot program and various control programs for the system.

The external memory apparatus (HDD) 5007 stores therein various programs for controlling the system, image data, and the like.

The operation unit I/F 5005, which is the interface unit for an operation unit (UI (user interface)) 5018, outputs to the operation unit 5018 the image data to be displayed on the operation unit 5018.

Further, the operation unit I/F 5005 functions to transfer, to the CPU 5001, the information (e.g., user information) input by the user from the operation unit 5018. Incidentally, since a display unit having a touch panel is provided on the operation unit 5018, the user can generate various instructions by depressing (touching with fingers) the buttons displayed on the display unit.

The network I/F 5003, which is connected to the network (LAN), inputs and outputs data.

The modem 5004, which is connected to the WAN, inputs and outputs facsimile transmission and reception data.

The external I/F 5009 is the interface unit which accepts external inputs such as inputs from as a USB (universal serial bus), an IEEE (Institute of Electrical and Electronics Engineers) 1394, a printer port, an RS-232C (Recommended Standard 232 version C), or the like. In the present embodiment, the card reader 300 for reading the IC card necessary for authentication is connected to the external I/F 5009.

Then, the CPU 5001 controls information reading from the IC card by the card reader 300 through the external I/F 5009, whereby it is possible to obtain the information read from the IC card. Here, although the IC card is used in the present embodiment, any storage medium capable of specifying a user may be used. In this case, a user ID (i.e., identification information) for identifying the user is stored in the storage medium. Here, the identification information may be a product serial number of the storage medium, or a user code given to the user in a company.

The above-described devices are disposed on the system bus.

On the other hand, the image bus I/F 5008 is the bus bridge which connects a system bus 5016 to an image bus 5017 for transferring image data at high speed, and thus converts a data structure.

The image bus 5017 is constituted by a PCI (Peripheral Component Interconnect) bus or an IEEE 1394 bus. In any case, the following devices are disposed on the image bus 5017.

The RIP 5010 extracts vector data such as a PDL (page description language) code or the like into bit map image data.

The printer I/F 5011 connects the printer 5014 to the controller unit 5000, and thus performs synchronous/asynchronous conversion for image data.

The scanner I/F 5012 connects the scanner 5015 to the controller unit 5000, and thus performs synchronous/asynchronous conversion for image data.

The image processing unit 5013 corrects, processes and edits input image data. Further, the image processing unit 5013 performs printer correction, resolution conversion and the like to print output image data. Furthermore, the image processing unit 5013 performs image data rotation, compression and extraction processes to multivalued image data according to a JPEG (Joint Photographic Experts Group) format, and compression and extraction processes to binary image data according to a JBIG (Joint Bi-level Image experts Group), MMR (Modified Modified READ (Relative Element Address Designate)) or MH (Modified Huffman) format.

The scanner 5015, which is connected to the scanner I/F 5012, converts an image on a paper original into an electrical signal as raster image data, by irradiating the image and then scanning it with a CCD (charge-coupled device) line sensor. After the paper original was set on a tray of a document feeder, when a reading start instruction by a user is issued from the operation unit 5018, the CPU 5001 instructs the scanner to cause the document feeder to feed and read the paper original one by one, thereby performing an original image reading operation.

The printer 5014, which is connected to the printer I/F 5011, is the unit for converting the raster image data into an image on a paper, in an electrophotographic method using a photosensitive drum, a photosensitive belt or the like, an inkjet method of directly printing the image on the paper by discharging inks from a micro-nozzle array, or the like. Such a print operation is started in response to an instruction from the CPU 5001. Incidentally, the printer 5014 has plural paper feeding stages for enabling the user to select different paper sizes and/or different paper directions, and plural paper cassettes respectively corresponding to the plural paper feeding stages.

The operation unit 5018, which is connected to the operation unit I/F 5005, has an LCD (liquid crystal display) unit on which a touch panel sheet has been applied to display the system operation screen, and transfers, when the displayed key is depressed, position information indicating the position of the depressed key to the CPU 5001 through the operation unit I/F 5005. Here, the operation keys provided on the operation unit 5018 include, for example, a start key, a stop key, an ID key, a reset key, and the like.

Here, the start key on the operation unit 5018 is used to start a reading operation of an original image. Two LEDs (light-emitting diodes) consisting of green and red LEDs are provided at the center of the start key, so as to indicate based on a color thereof whether the start key is in a usable state. The stop key on the operation unit 5018 is used to stop the operation which is being performed, the ID key on the operation unit 5018 is used to input the user ID of the user, and the reset key is used to initialize the setting from the operation unit 5018.

Under the control of the CPU 5001, the card reader 300 connected to the external I/F 5009 reads the information stored in the IC card (e.g., FeliCa™ manufactured by Sony Corporation), and notifies the CPU 5001 of the read information through the external I/F 5009.

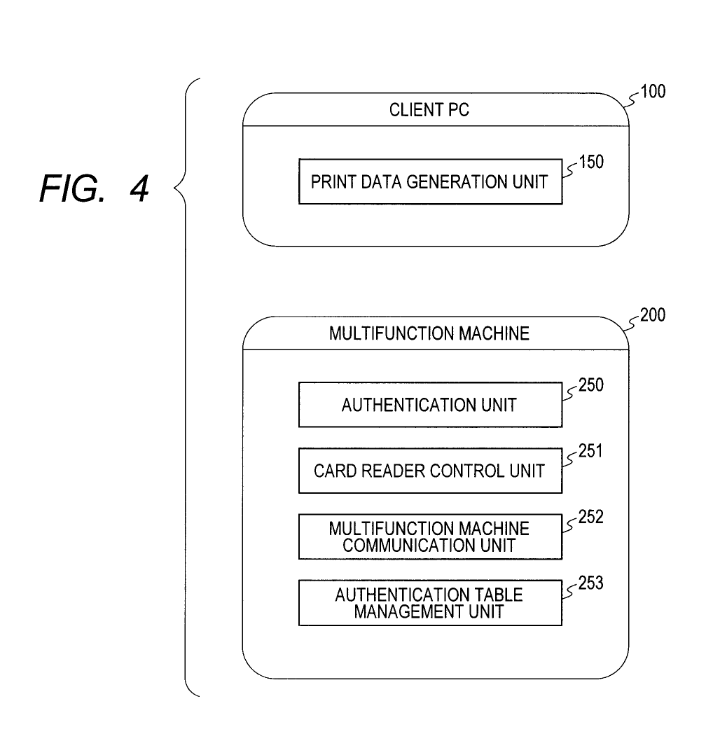

Subsequently, the functions of the client PC 100 and the multifunction machine 200 will be described with reference to FIG. 4.

Namely, FIG. 4 is the block diagram schematically illustrating the system configuration according to the embodiment of the present invention. In the system according to the embodiment of the present invention, the client PC 100 and each of the multifunction machines 200 are connected to each other through the predetermined LAN 400 capable of performing bidirectional communication. Further, the card reader 300 is connected to each of the multifunction machines 200.

In any case, the mutual operation flows among the connected devices will be described later. Here, the function block of each of the connected devices will be described.

<Client PC 100>

A print data generation unit 150 on the client PC has a function to generate print data (job) based on data received from an application program, and transmit the generated print data to the multifunction machine 200 or the like.

<Multifunction Machine 200>

An authentication unit 250 wholly controls an authentication system. When authentication succeeds, the authentication unit causes the authenticated user to use the multifunction machine by using the user information.

A card reader control unit 251 has a function to obtain the card information (product serial number) read by the card reader 300.

A multifunction machine communication unit 252 is used in a communication process to be performed between the multifunction machines in case of login by using an authentication table of another multifunction machine, i.e., redirect authentication.

An authentication table management unit 253 accesses the authentication table managed in the multifunction machine, searches for the user information tied to an authentication-requested card number or a user name and a password, and returns an authentication result.

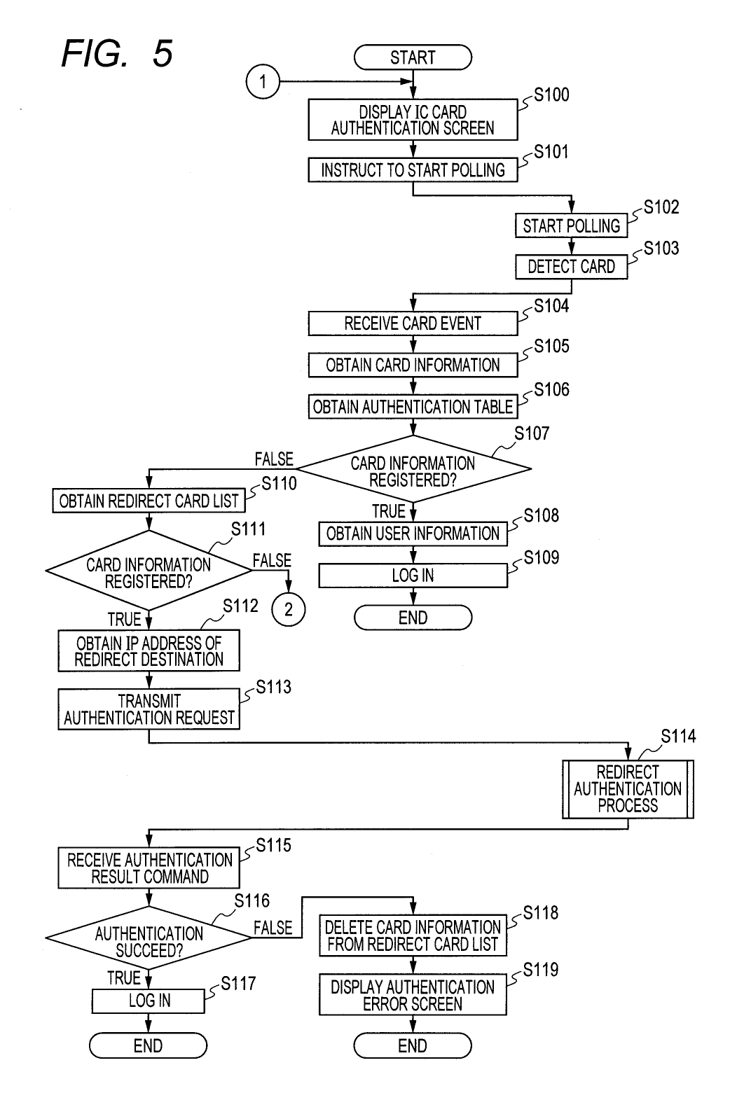

Subsequently, processes to be performed in the present embodiment will be described in detail with reference to flow charts illustrated in FIGS. 5, 6 and 7.

FIG. 5 is the flow chart illustrating an example of an IC card authentication process to be performed in the present embodiment. Here, processes of respective steps

S100, S101, and S104 to S119 in the flow chart illustrated in FIG. 5 are performed by the CPU 5001 of the multifunction machine 200 under the control of the predetermined control program read and executed by the CPU.

On the other hand, processes of respective steps S102 and S103 are performed by the card reader 300.

More specifically, in the step S100, an IC card authentication screen illustrated in FIG. 11 is displayed on the operation unit 5018 by the authentication unit 250 of the multifunction machine 200.

In the step S101, a card reading start command is transmitted from the card reader control unit 251 of the multifunction machine 200 to the card reader. That is, a polling start instruction command for reading the IC card is transmitted to the card reader.

In the step S102, when the card reader reading start command transmitted from the multifunction machine 200 in the step S101 is received by the card reader 300, and the card reader comes to be in an IC card reading state.

In the step S103, it is detected by the card reader 300 that the IC card was passed over, and a card event is transmitted to the multifunction machine 200. The card information of the passed card is stored in the card event.

Incidentally, as the card information, any kind of information can be used if it can identify a user. Namely, a product serial number stored in the IC card, a number capable of being arbitrarily stored in the IC card, a serial card name, or the like can be used.

In the step S104, the card event transmitted from the card reader 300 is received by the card reader control unit 251 of the multifunction machine 200.

In the step S105, the card information is obtained from the card event obtained in the step S104, by the authentication unit 250 of the multifunction machine 200.

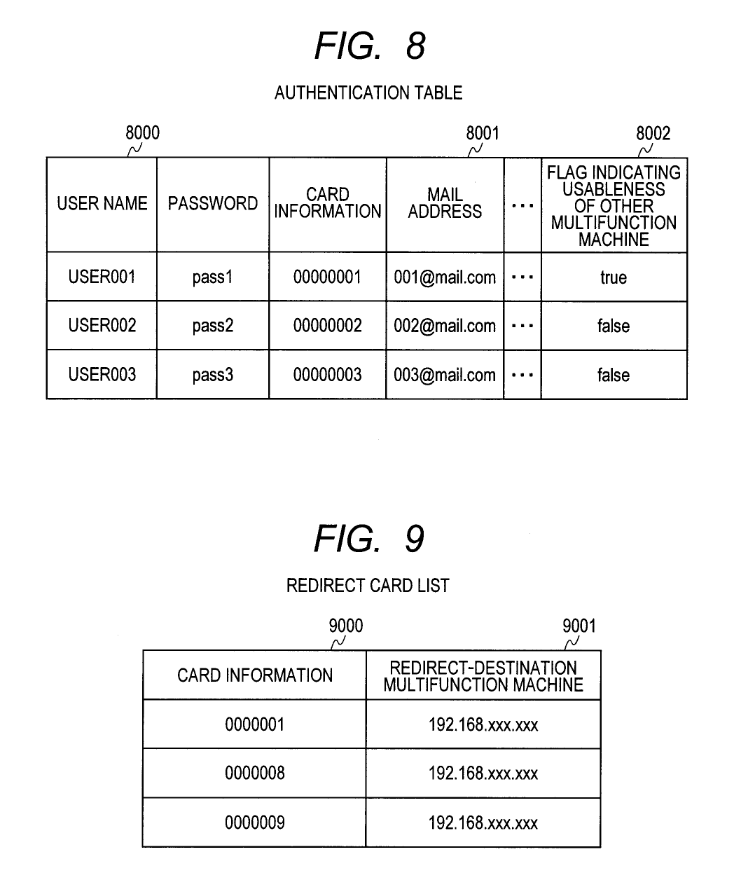

In the step S106, an authentication table illustrated in FIG. 8, which is managed in the ROM of the multifunction machine 200, is obtained by the authentication table management unit 253 of the multifunction machine 200.

In the step S107, it is determined by the authentication table management unit 253 of the multifunction machine 200 whether or not the card information obtained in the step S105 is present in the authentication table obtained in the step S106. When determined that the obtained card information is present in the obtained authentication table (TRUE in the step S107), the process moves to the step S108. On the other hand, when determined that the obtained card information is not present in the obtained authentication table (FALSE in the step S107), the process moves to the step S110.

In the step S108, the user information corresponding to the card information searched in the step S107 is obtained by the authentication unit 250 of the multifunction machine 200. Incidentally, a user name 8000, a mail address 8001, a certain flag 8002 and the like are included in the information obtained in this step.

In the step S109, the multifunction machine 200 is logged in by using the information obtained by the authentication unit 250 of the multifunction machine 200 in the step S108.

In the step S110, a redirect card list illustrated in FIG. 9, which is managed in the ROM of the multifunction machine 200, is obtained by the authentication table management unit 253 of the multifunction machine 200. Here, a card information 9000 and a redirect-destination multifunction machine 9001 are included in the redirect card list.

Incidentally, it should be noted that the redirect card list illustrated in FIG. 9 is the table on which the IP (Internet Protocol) address of the multifunction machine 200 in which the card information of the IC card passed over the card reader 300 has been registered is stored.

In the example illustrated in FIG. 9, the card information of “0000001” indicates that the relevant information has been registered in the multifunction machine of which the IP address is “192.168.xxx.xxx”.

In the step S111, it is determined by the authentication table management unit 253 of the multifunction machine 200 whether or not the card information obtained in the step S105 is present in the redirect card list obtained in the step S110. When determined that the obtained card information is present in the obtained redirect card list (TRUE in the step S111), the process moves to the step S112. On the other hand, when determined that the obtained card information is not present in the obtained redirect card list (FALSE in the step S111), the process moves to the processes in the flow chart of FIG. 6.

In the step S112, the IP address 9001 of the multifunction machine which is the redirect destination and tied to the card information searched in the step S111 is obtained by the authentication table management unit 253 of the multifunction machine 200.

In the step S113, an authentication request command is transmitted from the multifunction machine communication unit 252 of the multifunction machine 200 to the redirect-destination multifunction machine obtained in the step S111. Here, it should be noted that a flag indicating an authentication request and the card information obtained in the step S105 are included in the authentication request command.

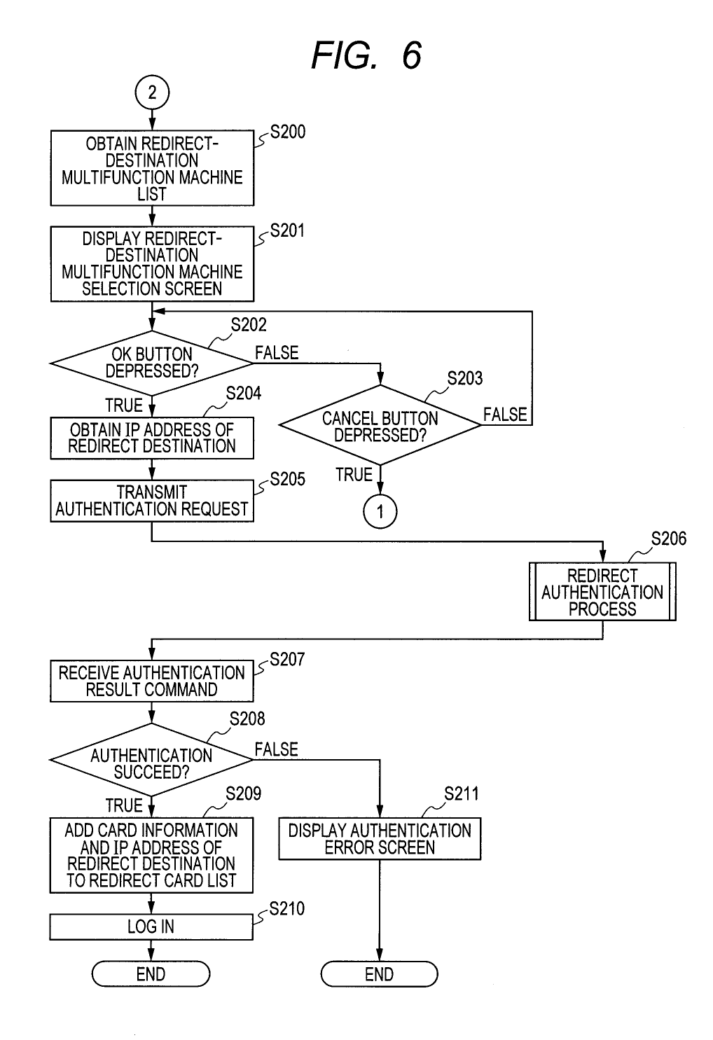

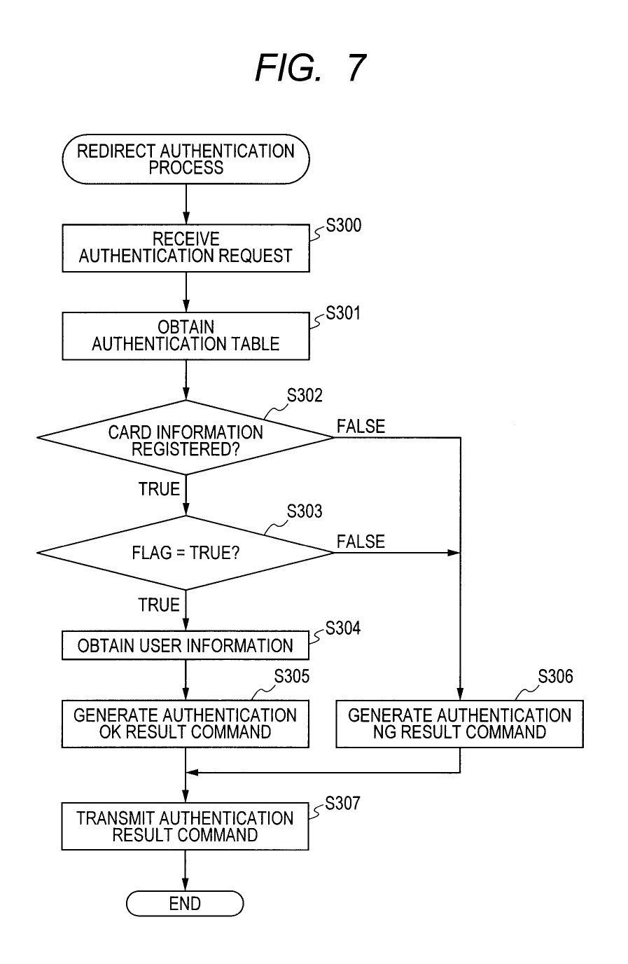

In the step S114, when the authentication request command is received by the multifunction machine communication unit 252 of the redirect-destination multifunction machine 200, a redirect authentication process is performed. Incidentally, the concrete redirect authentication process is performed according to steps S300 to S307 in the flow chart illustrated in FIG. 7.

In the step S115, an authentication result command, which is transmitted from the multifunction machine (redirect-destination multifunction machine) to which the authentication request command was transmitted in the step S113, is received by the multifunction machine communication unit 252 of the multifunction machine 200.

In the step S116, a result command included in the authentication result command received in the step S115 is confirmed by the authentication unit 250 of the multifunction machine 200. Here, when the authentication succeeded (TRUE in the step S116), the process moves to the step S117. On the other hand, when the authentication failed (FALSE in the step S116), the process moves to the step S118.

In the step S117, the multifunction machine 200 is logged in by using the user information included in the authentication result command obtained in the step S115, by the authentication unit 250 of the multifunction machine 200.

In the step S118, the card information is deleted from the redirect card list of FIG. 9 by the authentication table management unit 253 of the multifunction machine 200.

In the step S119, an authentication error screen illustrated in FIG. 13 is displayed on the operation unit 5018 by the authentication unit 250 of the multifunction machine 200.

FIG. 6 is the flow chart illustrating an example of a first redirect authentication process in the IC card authentication process according to the embodiment of the present invention. In other words, this flow chart indicates a process of performing redirect authentication in a case where card information is not registered in the redirect card list.

Here, the actual processes in the flow chart of FIG. 6 are performed by the CPU 5001 of the multifunction machine 200 under the control of the predetermined control program read and executed by the CPU.

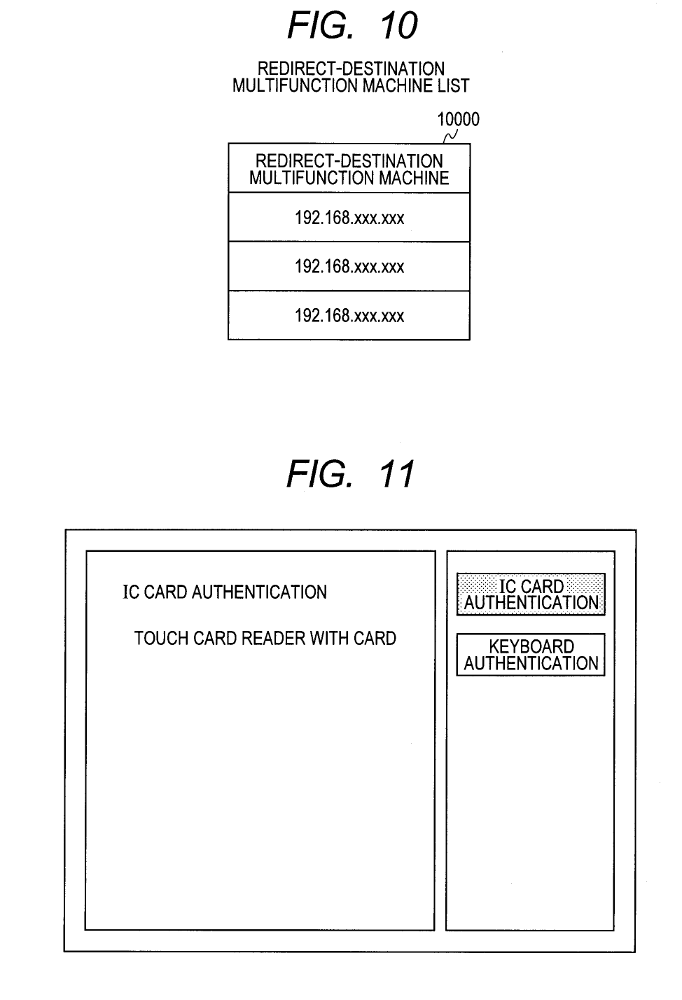

In a step S200, a redirect-destination multifunction machine list illustrated in FIG. 10, which is managed in the ROM of the multifunction machine 200, is obtained by the authentication table management unit 253 of the multifunction machine 200. Here, a redirect-destination multifunction machine 10000 is described on the redirect-destination multifunction machine list.

That is, when the card is passed over the card reader and the authentication fails in the multifunction machine, the redirect-destination multifunction machine list is displayed as the list of the multifunction machines which are permitted as the redirect destinations.

In the present embodiment, it is assumed that the redirect-destination multifunction machine list has been previously delivered to the multifunction machine by an administrator. However, the multifunction machine may collect the information of another communicable multifunction machine each time.

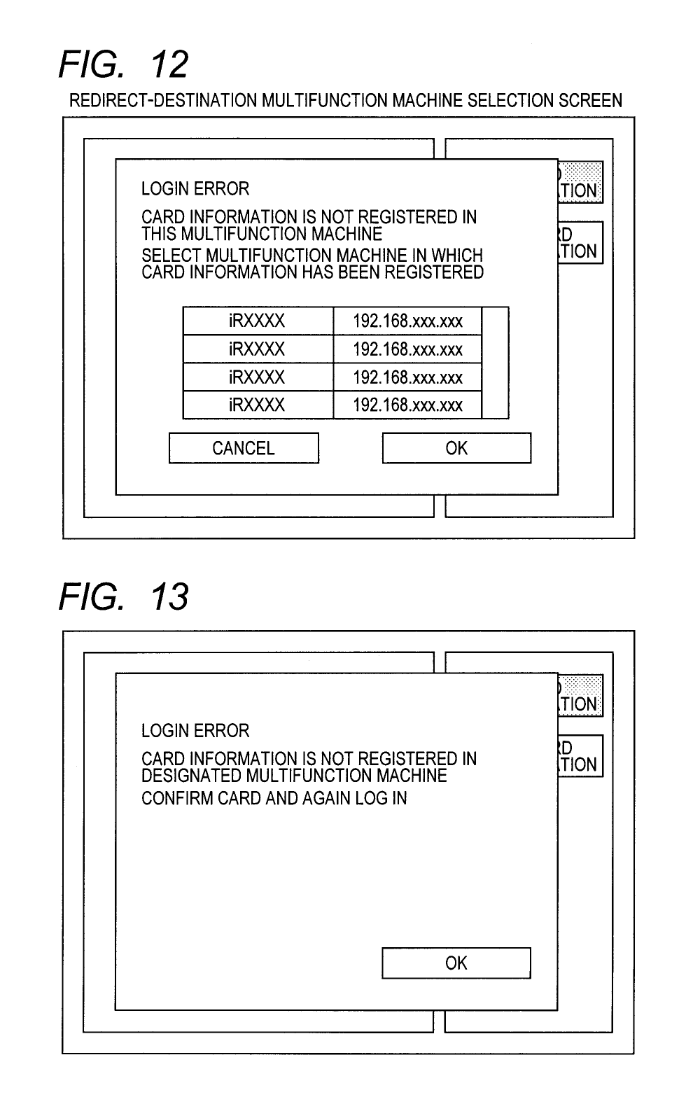

In a step S201, a redirect-destination multifunction machine selection screen illustrated in FIG. 12 is displayed on the operation unit 5018 by the authentication unit 250 of the multifunction machine 200. Since a list of the redirect-destination multifunction machine information obtained in the step S200 is displayed on the redirect-destination multifunction machine selection screen, a user can select an arbitrary multifunction machine and thus perform the redirect authentication process. Incidentally, the process to be performed when one multifunction machine is selected is described as one example in the present embodiment. However, a plurality of multifunction machines may be selected on the assumption that an authenticated user does not know in which multifunction machine the user information of own has been registered.

In a step S202, it is determined by the authentication unit 250 of the multifunction machine 200 whether or not the OK button on the redirect-destination multifunction machine selection screen illustrated in FIG. 12 is depressed. When determined that the OK button is depressed (TRUE in the step S202), the process moves to a step S204. On the other hand, when determined that the OK button is not depressed (FALSE in the step S202), the process moves to a step S203.

In the step S203, it is determined by the authentication unit 250 of the multifunction machine 200 whether or not the cancel button on the redirect-destination multifunction machine selection screen illustrated in FIG. 12 is depressed. When determined that the cancel button is depressed (TRUE in the step S203), the authentication process is stopped, and the process moves to the step S100. On the other hand, when determined that the cancel button is not depressed (FALSE in the step S203), the process moves to the step S202 to stand by until the OK button or the cancel button is depressed.

Incidentally, even in a case where any button is not depressed for a certain period of time, the process may move to the step S100.

In the step S204, the IP address of the multifunction machine selected from the plurality of multifunction machines displayed on the redirect-destination multifunction machine selection screen illustrated in FIG. 12 is obtained by the authentication unit 250 of the multifunction machine 200.

In a step S205, an authentication request command is transmitted to the redirect-destination multifunction machine obtained in the step S204, by the multifunction machine communication unit 252 of the multifunction machine 200. Here, it should be noted that a flag indicating an authentication request and the card information obtained in the step S105 are included in the authentication request command.

In a step S206, when the authentication request command is received from another multifunction machine by the multifunction machine communication unit 252 of the multifunction machine 200, the redirect authentication process is performed. Incidentally, the concrete redirect authentication process is performed according to the steps S300 to S307 in the flow chart illustrated in FIG. 7.

In a step S207, an authentication result command, which is transmitted from the multifunction machine (redirect-destination multifunction machine) to which the authentication request command was transmitted in the step S205, is received by the multifunction machine communication unit 252 of the multifunction machine 200.

In a step S208, a result command included in the authentication result command received in the step S207 is confirmed by the authentication unit 250 of the multifunction machine 200. Here, when the authentication succeeded (TRUE in the step S208), the process moves to a step S209. On the other hand, when the authentication failed (FALSE in the step S208), the process moves to a step S211.

In the step S209, the card information obtained in the step S105 and redirect-destination multifunction machine information of the redirect-destination multifunction machine from which the result command indicating that the authentication succeeded is transmitted are added to the redirect card list illustrated in FIG. 9, by the authentication table management unit 253 of the multifunction machine 200.

As a result of the process in the step S209, the card information for which the redirect authentication once succeeded is automatically registered in the redirect card list. For this reason, hereafter, the authentication process is redirected to another multifunction machine only by passing the card over the card reader, whereby the user can use the multifunction machine without regard to the redirect process.

In a step S210, the multifunction machine is logged in by using the user information included in the authentication result command obtained in the step S208 by the authentication unit 250 of the multifunction machine 200.

In the step S211, the authentication error screen illustrated in FIG. 13 is displayed on the operation unit 5018 by the authentication unit 250 of the multifunction machine 200.

FIG. 7 is the flow chart illustrating an example of the redirect authentication process to be performed when the authentication request is transmitted from another multifunction machine, in the embodiment of the present invention. Namely, this flow chart indicates the redirect authentication process in each of the steps S114 and S206.

Incidentally, the actual processes in the flow chart of FIG. 7 are performed by the CPU 5001 of the multifunction machine 200 under the control of the predetermined control program read and executed.

In the step S300, the authentication request command transmitted from another multifunction machine is received by the multifunction machine communication unit 252 of the multifunction machine 200.

In the step S301, the authentication table illustrated in FIG. 8, which is managed in the ROM of the multifunction machine, is obtained by the authentication table management unit 253 of the multifunction machine 200.

In the step S302, it is determined by the authentication table management unit 253 of the multifunction machine 200 whether or not the card information obtained in the step S300 is present in the authentication table obtained in the step S301. When determined that the obtained card information is present in the obtained authentication table (TRUE in the step S302), the process moves to the step S303. On the other hand, when determined that the obtained card information is not present in the obtained authentication table (FALSE in the step S302), the process moves to the step S306.

In the step S303, the another multifunction machine usable/unusable state flag 8002, in the information of the authentication table searched in the step S302, is confirmed by the authentication table management unit 253 of the multifunction machine 200. Here, the flag 8002 is the flag to be used for the registered user to set whether or not to permit the redirect authentication from another multifunction machine. When the flag 8002 is TRUE (in case of permitting the redirect authentication from another multifunction machine), the process moves to the step S304. On the other hand, when the flag 8002 is FALSE (in case of not permitting the redirection authentication from another multifunction machine), the process moves to the step S306.

In the step S304, the user information searched in the step S303 is obtained by the authentication table management unit 253 of the multifunction machine 200. Here, the user name 8000, the mail address 8001 and the like are included in the information to be obtained in this step.

In the step S305, the result command indicating that the authentication succeeded is generated by the authentication table management unit 253 of the multifunction machine 200. Here, the flag indicating that the authentication succeeded, the user name 8000, the mail address 8001 and the like obtained in the step S304 are included in the result command indicating that the authentication succeeded.

In the step S306, the result command indicating that the authentication failed is generated by the authentication table management unit 253 of the multifunction machine 200. Here, the flag indicating that the authentication failed, and the like are included in the result command indicating that the authentication failed.

In the step S307, the authentication result command is transmitted to the source from which the authentication request command was transmitted, by the multifunction machine communication unit 252 of the multifunction machine 200.

According to the above-described constitution, even in the case where the authentication table is provided on each multifunction machine and the multifunction machines are managed for each division, it is possible for user to use the multifunction machine in which the user oneself is not registered on the authentication table thereof, without deteriorating the maintenance capability of the authentication table.

Moreover, the programs to be executed in the present invention are the programs by which the computer can perform the processing methods respectively indicated by FIGS. 5 to 7. Incidentally, the program to be executed in the present invention may be the program for each of the processing methods of the apparatuses respectively indicated by FIGS. 5 to 7.

### Other Embodiments

Aspects of the present invention can also be realized by a computer of a system or apparatus (or devices such as a CPU or an MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-231907, filed Oct. 14, 2010, which is hereby incorporated by reference herein in its entirety.

What is claimed is:

1. An image forming apparatus which stores user IDs and communicates with another image forming apparatus, comprising:
an accepting unit configured to accept input of a user ID;
a determining unit configured to determine whether the accepted user ID corresponds to one of the stored user IDs;
a controlling unit configured to, in a case where the determining unit determines that the accepted user ID corresponds one of the stored user IDs, permit use of the image forming apparatus by the user;
a transmitting unit configured to, in a case where the determining unit determines that the accepted user ID corresponds to none of the stored user IDs, transmit an authentication request including the accepted user ID to the other image forming apparatus; and
a receiving unit configured to receive an authentication result for the transmitted authentication request, from the other image forming apparatus,
wherein the controlling unit permits, in a case where the received authentication result indicates that authentication succeeded, the use of the image forming apparatus by the user.

2. The image forming apparatus according to claim 1, further comprising a registering unit configured to, in a case where the received authentication result indicates authentication succeeded, register the accepted user ID and the other image forming apparatus.

3. The image forming apparatus according to claim 2, wherein the transmitting unit further transmits the authentication request including the accepted user ID to the registered image forming apparatus.

4. The image forming apparatus according to claim 1, further comprising a redirect-destination selection accepting unit configured to accept selection of the image forming apparatus being the transmission destination of the authentication request including the user ID,
wherein the transmitting unit transmits the authentication request including the user ID to the image forming apparatus of which the selection was accepted by the redirect-destination selection accepting unit.

5. The image forming apparatus according to claim 4, further comprising a second determining unit configured to determine whether the accepted user ID corresponds to the registered user ID,
wherein, in a case where the determining unit determines that the accepted user ID corresponds to none of the stored user IDs and the second determining unit determines that the accepted user ID does not correspond to the registered ID, the redirect-destination selection accepting unit accepts the selection of the image forming apparatus being the transmission destination of the authentication request including the user ID.

6. The image forming apparatus according to claim 4, wherein, in a case where the determining unit determines that the accepted user ID corresponds to none of the stored user IDs and the second determining unit determines that the accepted user ID corresponds to the registered ID, the transmitting unit transmits the authentication request including the accepted user ID to the image forming apparatus registered by the registering unit and corresponding to the user ID, without accepting the selection of the image forming apparatus being the transmission destination of the authentication request including the user ID by the redirect-destination selection accepting unit.

7. The image forming apparatus according to claims 1, further comprising a deleting unit configured to, in a case where the authentication result received by the receiving unit indicates that the authentication failed, delete, from the information registered by the registering unit, the accepted user ID and the image forming apparatus made correspondent to the accepted user ID.

8. An information processing method in an image forming apparatus which stores user IDs and communicates with another image forming apparatus, the method comprising:
accepting input of a user ID;
determining whether the accepted user ID corresponds to one of the stored user IDs;
permitting, in a case where it is determined that the accepted user ID corresponds to one of the stored user IDs, use of the image forming apparatus by the user;
transmitting, in a case where it is determined that the accepted user ID corresponds to none of the stored user IDs, an authentication request including the user ID to the other image forming apparatus;
receiving an authentication result for the transmitted authentication request, from the other image forming apparatus; and
permitting, in a case where the received authentication result indicates that authentication succeeded, the use of the image forming apparatus by the user.

9. A non-transitory computer-readable storage medium which stores a program for causing an image forming apparatus to perform the information processing method described in claim 8.
